(19) United States
(12) Patent Application Publication
(10) Pub. No.: US 2026/0195133 A1
(43) Pub. Date: Jul. 9, 2026

(54) Memory-Type Hierarchy for Instruction Patching

(71) Applicant: Google LLC, Mountain View, CA (US)

(72) Inventors: Janardan Prasad, Bangalore (IN); Ankit Bhargava, San Jose, CA (US)

(73) Assignee: Google LLC, Mountain View, CA (US)

(21) Appl. No.: 19/537,305

(22) Filed: Feb. 11, 2026

Related U.S. Application Data
(60) Provisional application No. 63/979,849, filed on Feb. 10, 2026.

(51) Int. Cl. G06F 9/30

(52) U.S. Cl. CPC G06F 9/30181; G06F 9/30043

(57) ABSTRACT

This document describes techniques for updating instructions (e.g., code) in electronic devices. These techniques provide or otherwise support memory-type, hierarchy-based instruction-patching capabilities. Some examples presented herein provide memory arrangements that may be circuit-area friendly and/or operating-power friendly while also providing efficient patching and low latency. By way of example, techniques are provided that may be implemented in an apparatus having a first type of memory configured to store a set of instructions, with the set of instructions including an N^{th} instruction, and a second type of memory configured to store a patch set of instructions, with the patch set of instructions including a Y^{th} patch instruction. The first type of memory is different from the second type of memory. The apparatus may include a module coupled to the first and second types of memory and configured to determine whether the N^{th} instruction is superseded by the Y^{th} patch instruction.

### CROSS-REFERENCE TO RELATED APPLICATION

This application claims the benefit of U.S. Provisional Ser. No. 63/979,849 filed on 10 Feb. 2026, the disclosure of which is incorporated by reference herein in its entirety.

### SUMMARY

In accordance with certain aspects of the present description, example techniques are provided that can be implemented in an apparatus having circuitry for determining whether an N^{th} instruction stored in a first type of memory is superseded based at least in part on a patched indicator associated with the N^{th} instruction. In response to determining that the N^{th} instruction is superseded, the circuitry identifies a Y^{th} patch instruction stored in a second type of memory that is a different memory type from the first type of memory. The circuitry further specifies the Y^{th} patch instruction as a K^{th} instruction for execution. On the other hand, in response to determining that the N^{th} instruction is not superseded, then the N^{th} instruction is specified as the K^{th} instruction for execution.

In accordance with certain other aspects of the present description, example techniques are provided that may be implemented in an apparatus having a first type of memory configured to store a set of instructions, with the set of instructions including an N^{th} instruction. The apparatus also has a second type of memory that is a different memory type from the first type of memory. The second type of memory is configured to store a patch set of instructions, with the patch set of instructions including a Y^{th} patch instruction. The apparatus includes multiple memory locations, which may be part of the first or second types of memory. The apparatus further includes a module that is coupled to the first type of memory, the second type of memory, and the multiple memory locations. The module is configured to determine whether the N^{th} instruction is superseded by the Y^{th} patch instruction based at least in part on a patched indicator stored in the multiple memory locations, the patched indicator associated with the N^{th} instruction and indicative of whether the N^{th} instruction is superseded. In response to the determination, the module specifies a K^{th} instruction for execution (e.g., the Y^{th} patch instruction or the N^{th} instruction).

In accordance with still other aspects of the present description, example techniques are related to patching instructions in an electronic device. First, a patch instruction set for a set of instructions that are stored in a first type of memory in the electronic device is received. Second, at least a portion of the patch instruction set is stored in a second type of memory in the electronic device. Here, the second type of memory is a different type of memory than the first type of memory. Third, the techniques also include updating one or more patched indicators associating the set of instructions with at least the portion of the patch instruction set that is stored in the second type of memory.

This summary is not intended to identify essential features of the claimed subject matter, nor is it intended for use in determining the scope of the claimed subject matter.

### BRIEF DESCRIPTION OF DRAWINGS

The details of one or more aspects of memory-type hierarchy instruction-patching techniques are described in this document with reference to the following drawings. The same numbers are used throughout the drawings to reference like features and components:

FIG. 1 is a block diagram of an example environment that includes an example electronic device having memory-type hierarchy instruction-patching capabilities, in accordance with certain example implementations of the present description;

FIG. 2 is a schematic diagram showing certain example aspects of memory-type hierarchy instruction-patching capabilities, e.g., as in FIG. 1, in accordance with certain example implementations of the present description;

FIG. 3 is a state diagram showing certain example control-related aspects of memory-type hierarchy instruction-patching capabilities, e.g., as in FIG. 1, in accordance with certain example implementations of the present description;

FIG. 4-1 is a schematic block diagram showing certain example components configured to support memory-type hierarchy instruction-patching capabilities, e.g., as in FIG. 1, in accordance with certain example implementations of the present description;

FIG. 4-2 is a schematic block diagram showing certain example components configured to support memory-type hierarchy instruction-patching capabilities, e.g., as in FIG. 1, in accordance with certain example implementations of the present description;

FIG. 5 is a flow diagram illustrating certain example actions that may be performed, at least in part, using an electronic device, e.g., as in FIG. 1, having memory-type hierarchy instruction-patching capabilities, in accordance with certain example implementations of the present description;

FIG. 6 is a flow diagram illustrating certain further example actions that may be performed, at least in part, using an electronic device, e.g., as in FIG. 1, having memory-type hierarchy instruction-patching capabilities, in accordance with certain example implementations of the present description; and

FIG. 7 is another flow diagram illustrating certain other example actions that may be performed, at least in part, using an electronic device, e.g., as in FIG. 1, to support memory-type hierarchy instruction-patching capabilities, in accordance with certain example implementations of the present description.

### DETAILED DESCRIPTION

### Overview

Modern system-on-chips (SoCs) that are targeted for low-power applications typically employ multiple on-chip power controllers to manage various power flows critical for chip operation, including power management (PM), boot, and initialization operations. The code required for these controllers is substantial, often reaching approximately 1 MB in size. Due to the complexity of these systems and the difficulty of simulating all corner cases at the SoC level—sometimes due to unknown silicon behaviors—critical bugs are often discovered late in the design cycle or during post-silicon validation. Consequently, the ability to patch code on silicon is important for ensuring SoC functionality.

Approaches for solving these problems involve significant trade-offs between area, power, and latency: For example, one approach is to store the entire code in flip-flop (FF) based memory. While this allows for easy overwriting and patching, it is highly inefficient regarding silicon area and power consumption. Another approach involves storing the code in system memory and downloading it to a central static random-access memory (SRAM) during the boot process. This approach, however, tends to introduce significant latency every time a subsystem powers up because the code is redownloaded. This latency can deteriorate the user experience and may limit the duration subsystems can remain in low-power (e.g., power-off) states or limit the frequency of entering such low-power states. In another approach, code is stored in read-only memory (ROM). ROM storage is more area and power-friendly, but ROM offers no capability for patching the ROM contents directly.

Accordingly, for these reasons and others, there is a continuing need for improved memory arrangements usage techniques that are more area and power-friendly while simultaneously supporting efficient patching and low-latency operation.

Techniques are presented herein by way of example for patching executable instructions in electronic devices. These techniques provide or otherwise support memory-type hierarchy instruction-patching capabilities. The examples presented herein provide memory arrangements that may be area and/or power-friendly while also providing efficient patching and low latency.

### Example Implementations

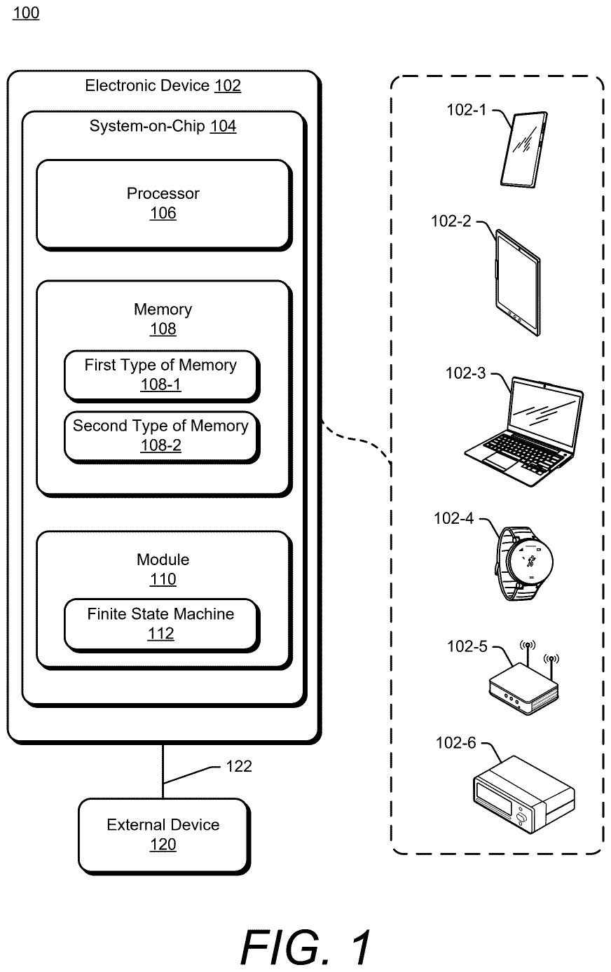

Attention is drawn to FIG. 1, which is a block diagram of an example environment 100 that includes an example electronic device 102 having memory-type hierarchy instruction-patching capabilities, in accordance with certain example implementations of the present description. The electronic device 102 is illustrated as including a system-on-chip (SoC) 104 having a processor 106, a memory 108, and a module 110. It is understood that the SoC 104 may also include other circuits, subsystems, or the like.

The processor 106 represents any electronic circuitry that may execute instructions stored in the memory 108. By way of some non-limiting examples, the processor 106 may include all or part of a graphics processing unit (GPU), a central processing unit (CPU), a tensor processing unit (TPU), an artificial intelligence (AI) engine, a media engine, a modem processor, an application-specific integrated circuit (ASIC), a sequencer, or the like. The processor 106 may be configured to provide or otherwise support one or more intended purposes of the electronic device 102 or the SoC 104. Although not shown in FIG. 1, it should also be understood that within the SoC 104, or otherwise within the electronic device 102, various other circuits and components may provide an operational infrastructure which may include, for example, communication interfaces, power management functions, clock management functions, one or more sensors, and the like to enable the operation and interoperability thereof.

As shown, the memory 108 can include two or more different types of electronic memory, as represented by a first type of memory 108-1 and a second type of memory 108-2. In accordance with certain example implementations, the first type of memory 108-1 may be used to store instructions, and the second type of memory 108-2 may be used to store updates to these instructions, e.g., in the form of a patch instruction set (e.g., one or more patch instructions). The patch instructions stored in the second type of memory 108-2 may be configured to replace one or more instructions stored in the first type of memory 108-1 or otherwise augment the instructions stored in the first type of memory 108-1. In certain instances, as described in greater detail herein, the first type of memory 108-1 may include a read-only memory (ROM), a programmable ROM (PROM), or the like, or some combination thereof. In certain instances, as described in greater detail herein, the second type of memory 108-2 may include a static random-access memory (SRAM), a static non-volatile random-access memory (S_{NV}RAM), a flash memory, or the like, or some combination thereof. In the context of this disclosure, the memory 108 may be implemented as a hardware-based or physical storage device, which does not include transitory signals or carrier waves.

The module 110 represents any circuitry that may support memory-type hierarchy instruction patching in the electronic device 102 or some portion thereof, e.g., the SoC 104. For example, the module 110 may be configured to receive and store patch instructions in the second type of memory 108-2. In certain instances, at least a portion of the patch instructions handled by the module 110 may, for instance, be received by the electronic device 102 or some portion thereof from an external device 120. The external device 120 is representative of any electronic device that is capable of providing one or more patch instructions to the electronic device 102 for use in a memory-type hierarchy instruction-patching capability.

By way of example, the external device 120 may include a computing platform, a server, a testing device, a storage device, a base station, or the like, which may be connected in some manner, at least momentarily, to the electronic device 102. For example, the external device 120 and the electronic device 102 may be connected (operatively coupled) via a wired communication interface, a wireless communication interface, or some combination thereof, as represented by a communication link 122. The communication link 122 may support bidirectional or unidirectional communication. The communication link 122 may be used specifically for supporting memory-type hierarchy instruction-patching capabilities or may also be used for additional purposes provided or otherwise supported by the electronic device 102.

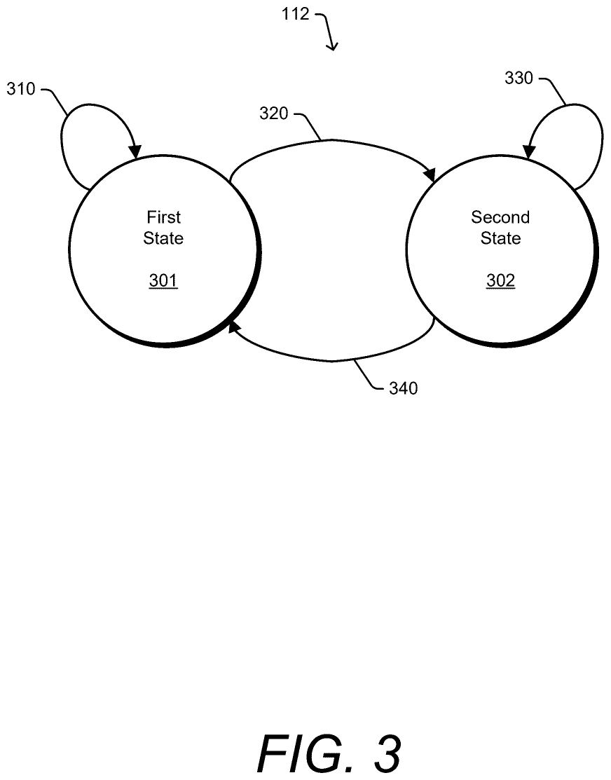

As shown, the module 110 may include a finite state machine (FSM) 112. The FSM 112 in FIG. 1 represents any circuitry that may be configured to support memory-type hierarchy instruction-patching capabilities, e.g., by controlling where each instruction is stored as part of a flow of instructions to be executed. Thus, for example, in certain instances the FSM 112 may be configured in a first state in which an instruction to be executed is from the first type of memory 108-1 and a second state in which a (patch) instruction to be executed is from the second type of memory 108-2. Further examples of such states are described with regard to FIG. 3.

As further illustrated, by way of some non-limiting examples, the electronic device 102 may take several forms. In certain instances, the electronic device 102 may be a mobile phone 102-1, a tablet device 102-2, a laptop computer 102-3, a wearable computing device 102-4, (e.g., smart watch, smart glasses, or a smart pin), a broadband router 102-5 (e.g., mobile hotspot), or an automotive computing system 102-6 (e.g., navigation and entertainment system or electronic control unit or system). Although not shown, the electronic device 102 may also be implemented as a mobile station (e.g., fixed or mobile station), a mobile communication device, a client device, a user equipment, an entertainment device, a gaming device, a mobile gaming console, a personal media device, a media playback device, a health monitoring device, a drone, a camera, a wearable smart-device, an Internet home appliance capable of wireless Internet access and browsing, an IoT device, and/or other types of user devices, including personal and professional devices. The electronic device 102 may provide other functions or include components or interfaces omitted from FIG. 1 for the sake of brevity or visual clarity.

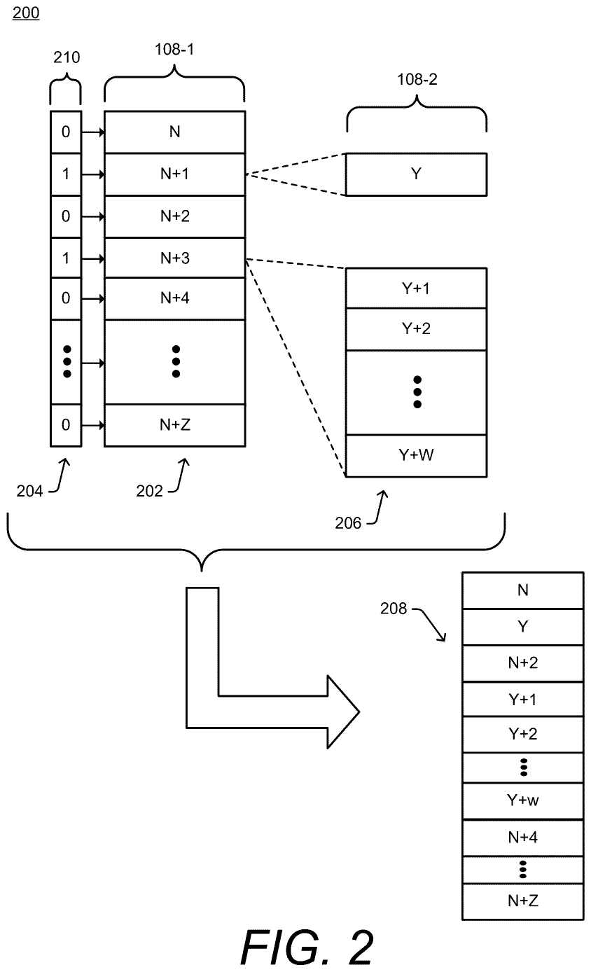

Attention is drawn next to FIG. 2, which is an illustrative diagram 200 showing certain example aspects of memory-type hierarchy instruction-patching capabilities, e.g., as may be provided in FIG. 1, in accordance with certain example implementations of the present description.

As shown, the diagram 200 includes a set of instructions 202 that may be stored in the first type of memory 108-1. The set of instructions 202 includes, by way of example, instructions N, N+1, N+2, N+3, N+4, through N+Z, wherein Z is a positive integer. While the set of instructions 202 is illustrated as being in a contiguous (addressed) order of Z+1 “N” instructions, it is understood that within an actual implementation of the first type of memory 108-1, the Z+1 “N” instructions may be arranged in a non-contiguous address order. Each of these “N” instructions may be referred to, for example, as an “original” instruction, as a “regular” instruction, as a “ROM” instruction, and so forth.

The diagram 200 includes a set of patch instructions 206 (or patch instruction set 206) that may be stored in the second type of memory 108-2. The set of patch instructions 206 includes, by way of example, instructions Y, Y+1, Y+2, through Y+W, wherein W is a positive integer. While the set of patch instructions 206 is illustrated as being in a contiguous (addressed) order of W+1 “Y” instructions, it is understood that within an actual implementation of the second type of memory 108-2, the W+1 “Y” instructions may be arranged in a non-contiguous address order. Each of these “Y” instructions may be referred to, for example, as a “patch” instruction, as a “replacement” instruction, as an “updated” instruction, and so forth.

The diagram 200 includes an example implementation of multiple memory locations 210 that are configured to store multiple patched indicators 204. The multiple memory locations 210 may be part of the first type of memory 108-1, part of the second type of memory 108-2, part of another portion of the memory 108, or some combination thereof. The multiple memory locations 210 may be formed using multiple flip-flops. For instance, each memory location 210 may include at least one flip-flop. Additionally or alternatively, each memory location 210 may include or store a single bit.

Here, each of the patched indicators 204 are associated with a corresponding N^{th} instruction of the set of instructions 202. Each of the patched indicators 204 in this example includes at least one bit (e.g., as few as a single bit) indicating (e.g., logically, as a Boolean “0” or “1”) if the corresponding N^{th} instruction has been superseded. For instance, each patch indicator 204 can indicate if the corresponding instruction of the set of instructions 202 does not have a related patch instruction/instruction set (e.g., represented by a “0”) or conversely if the corresponding instruction does have a related patch instruction/instruction set (e.g., represented by a “1”).

In the example shown in FIG. 2, the instructions N, N+2, N+4, and N+Z do not have any related patch instructions per the corresponding patched indicators 204 that are marked as logical “0.” In contrast, the instructions N+1 and N+3 do have one or more related patch instructions 206 per the corresponding patched indicators 204 that are marked as logical “1.” More specifically, in this example, the N+1 instruction is shown as being patched by the Y patch instruction, and the N+3 instruction is shown as being patched by the Y+1 through the Y+W patch instruction set. As used herein, a “patch instruction set” may include one or more patch instructions.

By way of illustration, the module 110 of FIG. 1 may determine an instruction execution flow 208 having the following order: instruction N; patch instruction Y (which replaces instruction N+1); instruction N+2; patch instructions Y+1 though Y+W (which replace instruction N+3); and instructions N+4 through N+Z. Each of these instructions may be referred to, for example, as an “execution” instruction, as an “execution flow” instruction, and so forth. A determination of such an order of execution flow 208 may be based at least in part by the patched indicators 204. It is understood that in other example implementations the format or other aspect of one or more of the patched indicators 204 may be different from the single logical bit example shown in FIG. 2. For example, a table may list those instructions (e.g., via a corresponding instruction location, like an address thereof) of the set of instructions 202 that have been superseded but omit those instructions that have not been superseded.

Attention is drawn next to FIG. 3, which is a state diagram 300 showing certain example aspects of memory-type hierarchy instruction patching, e.g., as may be provided at least in part by the module 110 of FIG. 1, in accordance with certain example implementations of the present description. The state diagram 300 may be implemented at least in part by FSM 112 (FIG. 1). As shown, the state diagram 300 can include a first state 301 and a second state 302.

The first state 301 may be indicative of a determination that an instruction (e.g., an “N^{th}” instruction in FIG. 2) stored in the first type of memory 108-1 (FIG. 1) is to be executed. An action 310 maintains the first state 301 as the active state. For example, the action 310 may include determining that the patched indicator 204 corresponding to a given instruction 202 stored in the first type of memory 108-1 does not indicate that the given instruction has been patched by one or more of the patch instructions 206 stored in the second type of memory 108-2. Conversely, an action 320 (or transition 320) may result from a determination that the patched indicator 204 corresponding to the given instruction stored in the first type of memory 108-1 does indicate that the given instruction has been patched by one or more of the patch instructions 206 stored in the second type of memory 108-2. As such, the second state 302 becomes the active state of the FSM 112 based on the action 320.

The second state 302 may be indicative of a determination that a patch instruction/instruction set (e.g., at least a “Y^{th}” instruction 206 in FIG. 2) stored in the second type of memory 108-2 (FIG. 1) is to be executed. The action 320 may provide a patch instruction/instruction set 206 for execution in place of a “regular” instruction 202. Also, for example, an action 330 can maintain the second state 302 as the active state. In some cases, the action 330 may include determining that the patched indicator 204 corresponding to a given instruction 202 stored in the first type of memory 108-1 does indicate that the given instruction 202 has been patched by one or more of the patch instructions 206 stored in the second type of memory 108-2. Additionally or alternatively, the action 330 may include executing multiple patch instructions 206 (or a patch instruction set 206) before transition “back” to the first state 301.

Conversely, an action 340 (or transition 340) may result from a determination that the patched indicator 204 corresponding to a given instruction 202 stored in the first type of memory 108-1 does not indicate that the given instruction 202 has been patched by one or more of the patch instructions 206 stored in the second type of memory 108-2. Additionally or alternatively, the transition 340 may occur or result from a determination that each patch instruction 206 in a current or applicable patch instruction set 206 has been performed at the second state 302 and that code execution is thus to return to the “regular” instructions 202. As such, the first state 301 becomes the active state of the FSM 112 as a result of the action 340.

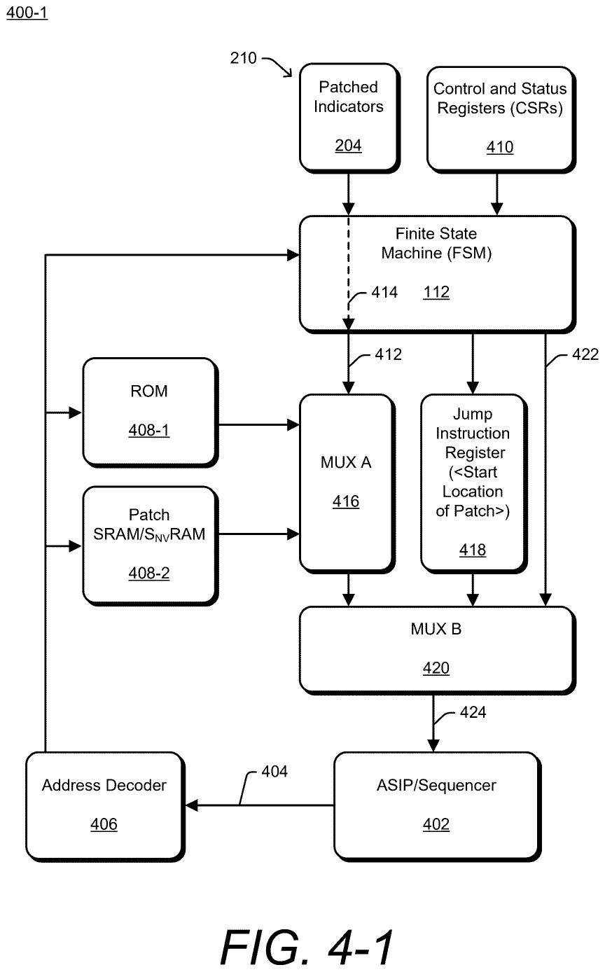

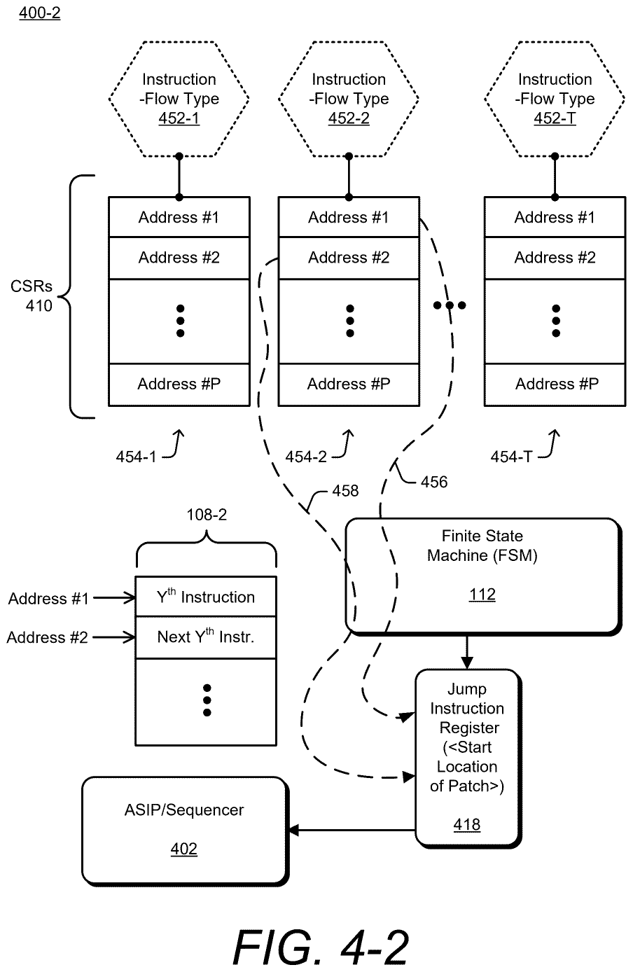

Attention is now drawn to FIG. 4-1, which is a schematic block diagram 400-1 showing certain example components configured to support memory-type hierarchy instruction-patching capabilities, e.g., as in the electronic device 102 or some portion thereof (FIG. 1), in accordance with certain example implementations of the present description.

Example schematic block diagram 400-1 includes an application-specific instruction-set processor (ASIP)/sequencer 402 which is configured to request or otherwise access instructions in an instruction flow of execution by the ASIP/sequencer 402 or optionally by other circuitry not shown in FIG. 4-1, e.g., the processor 106 in FIG. 1. In FIG. 4-1, the ASIP/sequencer 402 provides an address 404 to an address decoder 406. The address decoder 406 determines an applicable address with regard to one or both of a first type of memory 108-1 (e.g., a ROM 408-1) and a second type of memory 108-2 (e.g., a patch SRAM/S_{NV}RAM 408-2). The determined address from the address decoder 406 is also provided to the FSM 112.

The FSM 112 may, for example, implement all or part of the state diagram 300 (FIG. 3) or other decision or control circuitry. Here, the FSM 112 may be provided with the patched indicators 204 (e.g., from the multiple memory locations 210 of FIG. 2), as applicable for a given instruction determination function/process. The multiple memory locations 210 may be part of the ROM 408-1, the patch SRAM/S_{NV}RAM 408-2, some combination thereof, and so forth. Also, the FSM 112 may be provided with control and status registers (CSRs) 410, as applicable for a given instruction determination function/process. The CSRs 410 may indicate a starting location for a given instruction flow of multiple instruction flows, which is described herein with reference to FIGS. 4-1 and 4-2. The FSM 112 may assert selection signals 412 and 422 to a multiplexer (MUX) A 416 and MUX B 420, respectively. In certain example implementations, the selection signal 412 may be asserted instead from the patched indicators 204, for example as represented by dashed line connector 414.

The ROM 408-1 is illustrated as providing an instruction to the MUX A 416. The instruction from the ROM 408-1 is determined based at least in part on the address provided by the address decoder 406. Similarly, the patch SRAM/S_{NV}RAM 408-2 is illustrated as providing an applicable patch instruction to the MUX A 416. The patch instruction from the patch SRAM/S_{NV}RAM 408-2 may be determined (when applicable, e.g., when a patch instruction set exists) based at least in part on the address provided by the address decoder 406 to the patch SRAM/S_{NV}RAM 408-2.

The MUX A 416, being responsive to the selection signal 412, provides to MUX B 420 the instruction from the ROM 408-1 or the patch instruction from the patch SRAM/S_{NV}RAM 408-2. The MUX B 420 may also receive input from a jump (e.g., “JUMP”) instruction register 418 (e.g., in which a “<start location of patch>” address is stored therein). The jump instruction register 418 may be set, populated, or otherwise controlled by the FSM 112, for instance. Thus, the jump instruction register 418 may be maintained by the FSM 112 and represent, at least in part, the start location of the patch instruction set for a determined “JUMP” or switch to the patch instructions 206 from the “regular” instructions 202. The FSM 112 may, for example, set the jump instruction register 418 as indicated by the applicable CSRs 410 for a given instruction flow.

At the end of executing a patch instruction set 206 during the given instruction flow, the jump instruction register 418 may be set to indicate a next instruction location for a next set of patch instructions 206, e.g., within the patch SRAM/S_{NV}RAM 408-2, for the given instruction flow. Examples of implementing the CSRs 410 with different instruction flows is described below with reference to FIG. 4-2. The MUX B 420, per the selection signal 422 from the FSM 112, provides to ASIP/Sequencer 402 the instruction output by MUX A 416 or the jump instruction—including a target address location in the SRAM/S_{NV}RAM 408-2—as per the jump instruction register 418.

If the patch indicator 204 corresponding to a current instruction 202 in the ROM 408-1 is set for (e.g., is indicative that execution should switch to) the patch instruction set 206 (FIG. 2), the FSM 112 changes the selected input of the MUX A 416 via the selection signal 412 to select the SRAM/S_{NV}RAM 408-2. Further, the ASIP/sequencer 402 is “jumped” to the location indicated by the <start location of patch> in the JUMP register 418 by returning to the ASIP/sequencer 402 a jump instruction having an appropriate target address into the SRAM/S_{NV}RAM 408-2. To do so, the FSM 112 can use the selection signal 422 to cause the MUX B 420 to forward the input received from the jump instruction register 418 before switching the MUX B 420 back to forwarding information received from the MUX A 416. The <start location of patch>field in the jump instruction register 418 may be updated by the FSM 112 on the start of each new instruction flow by a value indicated in the CSRs 410 for the patch code location for an applicable instruction flow, as described further with reference to FIG. 4-2. The <start location of patch> field in the jump instruction register 418 may be updated by the FSM 112 at the end of executing one patch instruction set 206 to match the location of the next patch instruction set 206 within the patch SRAM/S_{NV}RAM 408-2.

If the ASIP/sequencer 402 is executing a particular instruction flow, a program counter (PC) (not shown) maintained thereby may, for example, be “jumped” to the address included in the jump instruction register 408 by returning to the ASIP/sequencer 402 a jump instruction having an appropriate target address into the SRAM/S_{NV}RAM 408-2. Here, the address in the jump instruction register 418 can correspond to, e.g., the <start location of the next flow patch code> in the patch SRAM/S_{NV}RAM 408-2 for the current instruction flow. The ASIP/sequencer 402 may then start executing the code from the patch SRAM/S_{NV}RAM 408-2. At the end of execution of the patch instruction set 206 in the SRAM/S_{NV}RAM 408-2, ASIP/sequencer 402 is to continue executing the ROM, original, or “regular” instructions 202 in the ROM 408-1.

To cause this change to the PC, a “final” instruction 206 in the set of patch instructions 206 can include a “jump” instruction to indicate that the PC is to jump to a “next” location from where it jumped originally from the ROM 408-1 (e.g., where the patch instruction set was initiated). For instance, if an instruction 202 in the ROM 408-1 having an address <0012> is associated with a set patched indicator 204, the “final” patch instruction 206 (which may be an “only,” a second, a third, etc. patch instruction 206) of the set of patch instructions 206 in the SRAM/S_{NV}RAM 408-2 can include a jump instruction targeting the address <0013> in the ROM 408-1. Subsequently or overlapping in time, the FSM 112 may store information regarding a next location in the patch SRAM/S_{NV}RAM 408-2 in the jump instruction register 418 (e.g., indicating a “JUMP” location of a next patch instruction set for the current instruction flow).

The FSM 112 can use the selection signal 412 to cause the MUX A 416 to forward instructions 202 from the ROM 408-1 onward—e.g., to the MUX B 420. The instruction flow of execution per the PC may continue with instructions from the ROM 408-1 until the next instruction 202 associated with a memory location 210 having a patched indicator 204 that is set (e.g., marked as a “1”). At such a point in the execution process, the FSM 112 can use the selection signal 422 to change the output of the MUX B 420 such that the ASIP/sequencer 402 receives from the jump instruction register 418 a jump instruction and the next targeted address into the SRAM/S_{NV}RAM 408-2. The ASIP/sequencer 402 can therefore start executing patch instructions 206 from the SRAM/S_{NV}RAM 408-2 as per a location where patch instructions for the current flow are next located. At the end of execution of the patch instruction set 206 (e.g., responsive to a jump instruction included therein back to the “regular” instructions 202), the FSM 112 may change the input selection of the MUX A 416 such that the ASIP/sequencer 402 is again provided with instructions 202 from the ROM 408-1.

Attention is now drawn to FIG. 4-2, which is a schematic block diagram 400-2 showing certain example components configured to support memory-type hierarchy instruction-patching capabilities, e.g., as in the electronic device 102 or some portion thereof (FIG. 1), in accordance with certain example implementations of the present description. In FIG. 4-2, example implementations of the CSRs 410 are depicted. Some components that are shown in FIG. 4-1 are omitted from FIG. 4-2 for clarity.

Some implementations can support different functional modes, including various power-management modes. Examples of such modes include boot, initialization, reset, power gating, clock gating, and so forth. These different functional modes may be associated with different sets of instructions to be executed by the ASIP/sequencer 402. The components of FIGS. 4-1 and 4-2 can accommodate these different instruction flows with different sets of patch instructions 206 in the patch SRAM/S_{NV}RAM 408-2, and with different sets of instructions 202 in the ROM 408-1. To properly execute the patch instructions on a per-mode basis, the CSRs 410 can include mode-specific sets of addresses pointing to the mode-specific sets of patch instructions 206.

Generally, one or more registers of the CSRs 410 store at least one address associated with the second type of memory 108-2 (e.g., the patch SRAM/S_{NV}RAM 408-2). At least one instruction register 418 stores a target address for a jump instruction. In example operations, the FSM 112 loads the at least one address from the one or more registers of the CSRs 410 into the at least one instruction register 418 as the target address for the jump instruction. In these manners, the FSM 112 can specify a particular patch instruction 206 (e.g., an N^{th} instruction) in the patch SRAM/S_{NV}RAM 408-2 as the current instruction (e.g., the K^{th} instruction) for execution by forwarding the target address for the jump instruction from the at least one instruction register 418 to a processor, like the ASIP/sequencer 402.

As shown in FIG. 4-2, the one or more registers of the CSRs 410 can be organized into multiple sets of registers 454-1, 454-2, through 454-T, where “T” is a positive integer (e.g., greater than one for multiple sets). Each set of registers 454 includes or stores multiple addresses—e.g., a first address #1, a second address #2, through a P^{th} address, with “P” representing a positive integer. Each set of registers 454 of the multiple sets of registers 454-1 to 454-T respectively corresponds to an instruction-flow type 452 of multiple instruction-flow types 452-1, 452-2, through 452-T. Examples of different types of instruction flows include boot, initialization (INIT), reset, automatic or adaptive power gating (APG), automatic or adaptive clock gating (ACG), dynamic voltage and frequency scaling (DVFS), other power-management flows, and so forth.

In example operations, the FSM 112 can load at least one address (e.g., the address #1) from a particular set of registers 454-2 of the multiple sets of registers 454-1 to 454-T into the at least one instruction register 418 as the target address for the jump instruction, as depicted at dashed arrow 456. This loading may be based on a current instruction-flow type 452-2 matching a particular instruction-flow type 452-2 that is associated with the particular set of registers 454-2. For instance, if the ASIP/sequencer 402 is operating in an initialization mode, the instruction-flow type 452 for initialization is the current instruction-flow type, and a selected particular set of registers 454 is likewise associated with the initialization instruction-flow type. The FSM 112 can also load a next address (e.g., the address #2) from the one or more registers of the CSRs 410 into the at least one instruction register 418 as the next target address for a next jump instruction before determining that a next N^{th} instruction is to be superseded by a next Y^{th} instruction (or a Y+1^{th} instruction) that is located at the upcoming next target address in the second type of memory, as depicted at dashed arrow 458. This “pre-loading” of the jump instruction register 418 before determining that the address therein is to be sent to the ASIP/sequencer 402 reduces latency during the utilization of the ROM patch. In some cases, the FSM 112 can perform this pre-loading in response to detecting that a decoded instruction from the address decoder 406 has returned to addressing the ROM 408-1 or that an instruction from the patch SRAM/S_{NV}RAM 408-2 is a jump instruction (e.g., perform the pre-loading at least substantially simultaneously or overlapping with the implementation of such a jump instruction “back” to accessing the ROM 408-1).

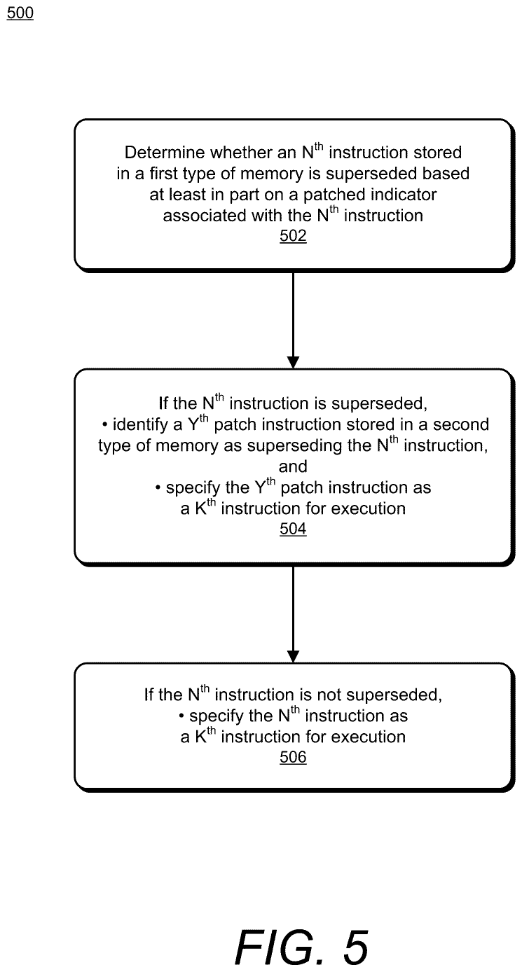

Attention is drawn next to FIG. 5, which is a flow-diagram 500 illustrating certain example actions that may be performed, at least in part, using the electronic device 102, e.g., as in FIG. 1, having memory-type hierarchy instruction-patching capabilities, in accordance with certain example implementations of the present description.

At block 502, whether an N^{th} instruction that is stored in a first type of memory 108-1 is superseded is determined based at least in part on a patched indicator associated with the N^{th} instruction. For example, the FSM 112 may make this determination based at least in part on at least one patched indicator 204 that is associated with at least one N^{th} instruction. The FSM 112 may, for instance, determine if an instruction of a set of instructions 202 is superseded by at least one patch instruction of a patch set of instructions 206.

At block 504, in response to determining that the N^{th} instruction is superseded, an action includes identifying a Y^{th} patch instruction as superseding the N^{th} instruction. Here, the Y^{th} patch instruction is stored in a second type memory 108-2 that is a different type from the first type of memory 108-1. Further, another action can include specifying the Y^{th} patch instruction as a K^{th} instruction for execution. In some cases, the FSM 112 may change from the first state 301 to the second state 302 so that at least one patch instruction of the patch instruction set 206 is provided for execution, e.g., from the patch SRAM/S_{NV}RAM 408-2 to the ASIP/sequencer 402 via the MUX A 416.

At block 506, in response to determining that the N^{th} instruction is not superseded, the N^{th} instruction is specified as the K^{th} instruction for execution. For example, the FSM 112 may have a first state 301 activated to provide this portion of the instruction flow, e.g., from the ROM 408-1 to the ASIP/sequencer 402 via the MUX A 416. To do so, the FSM 112 may select the output of the MUX A 416 with the selection signal 412, which may be based on the patched indicators 204.

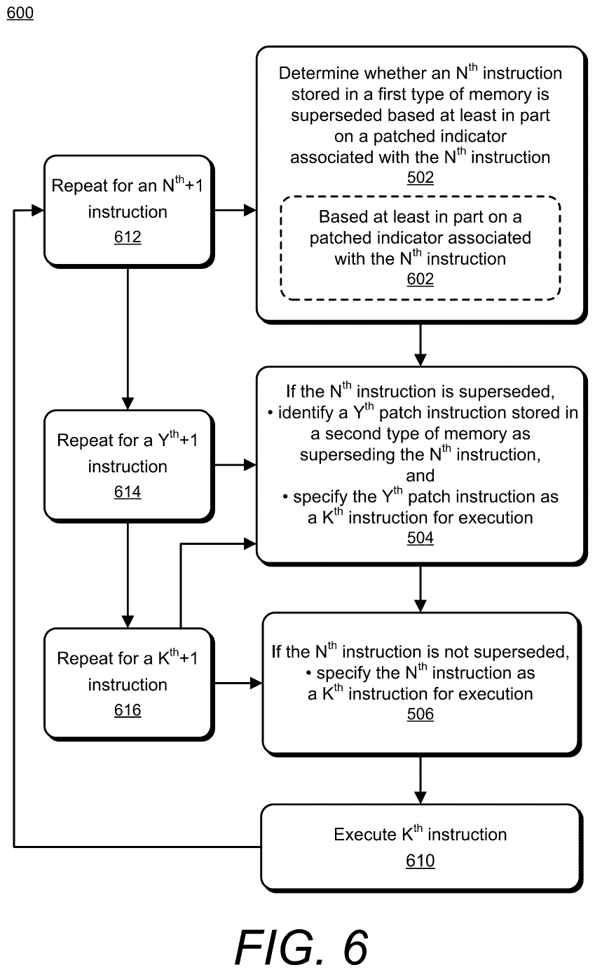

Attention is now drawn to FIG. 6, which is a flow-diagram 600 illustrating certain further example actions that may be performed, at least in part, using an electronic device, e.g., as in FIG. 1, having memory-type hierarchy instruction-patching capabilities, in accordance with certain example implementations of the present description. The flow diagram 600 includes the example blocks 502, 504, and 506 from the flow diagram 500 in FIG. 5 and is intended to further illustrate an example iterative process.

A block 602 is included in which the determination performed at block 502 may be based at least in part on the patched indicator 204 associated with the N^{th} instruction. The FSM 112 may perform this action as described herein. The patched indicator 204 may be realized, for instance, with a Boolean value, like a single bit per N^{th} instruction.

At block 610, the K^{th} instruction is executed. Once the K^{th} instruction has been executed, then an iterative process may be performed as per example blocks 612, 614, and 616. At block 612, the N^{th} instruction in block 502 is iterated to an N^{th}+1 instruction stored in the first type of memory, e.g., the ROM 408-1. At block 614, the Y^{th} patch instruction in block 504 is iterated to a Y^{th}+1 patch instruction stored in the second type of memory, e.g., the patch SRAM/S_{NV}RAM 408-2. At block 616, the K^{th} instruction for execution in block 504 or in block 506 is iterated to a K^{th}+1 instruction for execution.

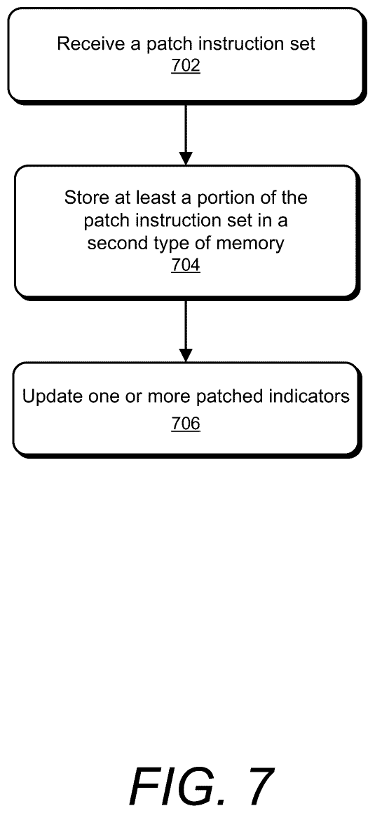

Attention is now drawn to FIG. 7, which is a flow-diagram 700 illustrating certain example actions that may be performed, at least in part, using an electronic device 102, e.g., as in FIG. 1, to support memory-type hierarchy instruction-patching capabilities, in accordance with certain example implementations of the present description. The flow diagram 700 illustrates a method for patching instructions in the electronic device 102.

At block 702, a patch instruction set 206 is received for a set of instructions 202 stored in the first type of memory 108-1 in the electronic device 102. For example, the patch instructions may be received from outside of the SoC 104, from the external device 120, a combination thereof, and so forth (FIG. 1).

At block 704, at least a portion of the patch instruction set 206 that is received at block 702 may be stored in the second type of memory 108-2 in the electronic device 102. Here, the second type of memory 108-2 is a different type of memory than the first type of memory 108-1 in which the set of instructions 202 is stored.

At block 706, one or more of the patched indicators 204 may be updated, like being changed, adjusted, or created. In some cases, the patched indicators 204 may associate the set of instructions 202 that is stored in the first type of memory 108-1 with at least the portion of the patch instruction set 206. In certain instances, the example action of block 702 may include receiving the one or more patched indicators 204. Additionally or alternatively, the example action of block 706 may include storing the one or more patched indicators 204 in the first type of memory 108-1, the second type of memory 108-2, another memory, some combination thereof, and so forth.

The techniques presented herein address important needs in modern SoC design in which ROM instructions are patched, e.g., after the initial silicon is finalized. Such techniques provide or otherwise support memory-type hierarchy instruction-patching capabilities using described memory and control arrangements. These memory and control arrangements can be configured in a chip-area-friendly and/or a power-friendly manner while also possibly providing efficient instruction (e.g., code) patching with low latency implementations during operation.

Although aspects of memory-type hierarchy instruction patching have been described in language specific to features and/or methods, the subject of the appended claims is not necessarily limited to the specific features or methods described. Rather, the specific features and methods are disclosed as example implementations of the techniques, and other equivalent features and methods are intended to be within the scope of the appended claims. Further, various aspects are described, and it is appreciated that each described aspect can be implemented independently or in connection with one or more other described aspects.

What is claimed is:

1. An apparatus comprising:
a first type of memory configured to store a set of instructions, the set of instructions including an N^{th} instruction;
a second type of memory configured to store a patch set of instructions, the patch set of instructions including a Y^{th} patch instruction, the second type of memory different from the first type of memory;
multiple memory locations; and
a module coupled to the first type of memory, the second type of memory, and the multiple memory locations, the module configured to:
determine whether the N^{th} instruction is superseded by the Y^{th} patch instruction based at least in part on a patched indicator stored in the multiple memory locations, the patched indicator associated with the N^{th} instruction and indicative of whether the N^{th} instruction is superseded, and
in response to a determination that the N^{th} instruction is superseded by the Y^{th} patch instruction, specify the Y^{th} patch instruction as a K^{th} instruction for execution, or
in response to a determination that the N^{th} instruction is not superseded by the Y^{th} patch instruction, specify the N^{th} instruction as the K^{th} instruction for execution.

2. The apparatus of claim 1, wherein the multiple memory locations comprise at least part of the first type of memory or at least part of the second type of memory.

3. The apparatus of claim 1, wherein:
the multiple memory locations comprise multiple flip-flops; and
each memory location of the multiple memory locations is configured to store a single bit.

4. The apparatus of claim 1, further comprising:
a processor coupled to the module and configured to execute the K^{th} instruction as specified by the module.

5. The apparatus of claim 4, wherein:
the apparatus comprises a system-on-chip (SoC); and
the system-on-chip comprises the first type of memory, the second type of memory, the multiple memory locations, the module, and the processor.

6. The apparatus of claim 1, further comprising:
one or more registers configured to store at least one address associated with the second type of memory; and
at least one register configured to store a target address for a jump instruction,
wherein the module is configured to:
load the at least one address from the one or more registers into the at least one register as the target address for the jump instruction; and
specify the Y^{th} patch instruction as the K^{th} instruction for execution by forwarding the target address for the jump instruction from the at least one register to a processor.

7. The apparatus of claim 6, wherein:
the one or more registers comprise multiple sets of registers;
each set of registers of the multiple sets of registers respectively corresponds to an instruction-flow type of multiple instruction-flow types; and
the module is configured to load the at least one address from a particular set of registers of the multiple sets of registers into the at least one register as the target address for the jump instruction based on a current instruction-flow type matching a particular instruction-flow type associated with the particular set of registers.

8. The apparatus of claim 6, wherein:
the module is configured to load a next address from the one or more registers into the at least one register as the next target address for a next jump instruction before determining a next N^{th} instruction is to be superseded by a next Y^{th} instruction that is located at the next target address in the second type of memory.

9. The apparatus of claim 1, wherein the module is configured to specify a memory location that is indicative of the K^{th} instruction for execution.

10. The apparatus of claim 1, wherein:
the N^{th} instruction comprises a single instruction; and
the Y^{th} patch instruction comprises multiple patch instructions stored in the second type of memory.

11. The apparatus of claim 1, wherein, subsequent to the K^{th} instruction being executed, the module is configured to:
determine whether an N^{th}+1 instruction is superseded by a Y^{th}+1 patch instruction based at least in part on another patched indicator stored in the multiple memory locations, the other patched indicator associated with the N^{th}+1 instruction and indicative of whether the N^{th}+1 instruction is superseded; and
in response to a determination that the N^{th}+1 instruction is superseded by the Y^{th}+1 patch instruction, specify the Y^{th}+1 patch instruction as a K^{th}+1 instruction for execution; or
in response to a determination that the N^{th}+1 instruction is not superseded by the Y^{th}+1 patch instruction, specify the N^{th}+1 instruction as the K^{th}+1 instruction for execution.

12. The apparatus of claim 1, wherein:
the module includes a finite state machine (FSM) configured to define:
a first state in which:
the N^{th} instruction is not superseded by the Y^{th} patch instruction, and
the K^{th} instruction to be specified for execution is the N^{th} instruction; and
a second state in which:
the N^{th} instruction is superseded by the Y^{th} patch instruction, and
the K^{th} instruction to be specified for execution is the Y^{th} patch instruction; and
the finite state machine is configured to:
transition from the first state to the second state if the N^{th} instruction is superseded by the Y^{th} patch instruction; and
transition from the second state back to the first state in response to completion of the execution of the Y^{th} patch instruction.

13. The apparatus of claim 1, wherein:
the first type of memory comprises at least one of a read-only memory (ROM) or a programmable ROM (PROM); and
the second type of memory comprises at least one of a static random-access memory (SRAM), a static non-volatile random-access memory (SnvRAM), or a flash memory.

14. A method comprising:
determining whether an N^{th} instruction stored in a first type of memory is superseded based at least in part on a patched indicator associated with the N^{th} instruction; and
in response to determining that the N^{th} instruction is superseded:
identifying a Y^{th} patch instruction as superseding the N^{th} instruction, the Y^{th} patch instruction being stored in a second type of memory that is a different type from the first type of memory, and
specifying the Y^{th} patch instruction as a K^{th} instruction for execution.

15. The method of claim 14, further comprising:
in response to determining that the N^{th} instruction is not superseded, specifying the N^{th} instruction as the K^{th} instruction for execution.

16. The method of claim 15, wherein:
the N^{th} instruction comprises a single instruction; and
the Y^{th} patch instruction comprises multiple patch instructions.

17. The method of claim 15, further comprising, subsequent to the K^{th} instruction being executed, iteratively repeating the method, wherein:
the N^{th} instruction comprises an N^{th}+1 instruction stored in the first type of memory;
the Y^{th} patch instruction comprises a Y^{th}+1 patch instruction stored in the second type of memory; and
the K^{th} instruction for execution comprises a K^{th}+1 instruction for execution.

18. A method for patching instructions in an electronic device, the method comprising:
receiving a patch instruction set for a set of instructions stored in a first type of memory in the electronic device;
storing at least a portion of the patch instruction set in a second type of memory in the electronic device, the second type of memory being a different type of memory than the first type of memory; and
updating one or more patched indicators associating the set of instructions with at least the portion of the patch instruction set stored in the second type of memory.

19. The method of claim 18, further comprising:
receiving, at a system-on-chip (SoC), the one or more patched indicators,
wherein the updating of the one or more patched indicators comprises storing the one or more patched indicators in at least one of the first type of memory or the second type of memory.

20. The method of claim 18, wherein the updating of the one or more patched indicators comprises:
setting the one or more patched indicators to indicate that one or more of respective associated instructions of the set of instructions are superseded by at least one instruction of at least the portion of the patch instruction set stored in the second type of memory.
